(19) United States
(12) Patent Application Publication
(10) Pub. No.: US 2003/0145330 A1
(43) Pub. Date: Jul. 31, 2003

(54) Video broadcast program non-synchronous watching system

(76) Inventors: Chi-Tai Lin, Taipei (TW); Ying-Liang Ding, Taipei City (TW); Chao-Wei Sung, Taipei City (TW); Chang-Tai Yu, Yi-Lan City (TW)

Correspondence Address: SUPREME PATENT SERVICES, POST OFFICE BOX 2339, SARATOGA, CA, 95070, US

(21) Appl. No.: 10/062,922

(22) Filed: Jan. 31, 2002

(51) Int. Cl. H04N 7/20; H04N 7/173; G06F 15/16

(52) U.S. Cl. 725/109; 709/219; 725/118

(57) ABSTRACT

A video broadcast program non-synchronous watching system includes at least one film end computer, at least one film server, at least one video broadcast system, and at least one user end computer. The film end computer may combine a digital film data and an analog type film into an analog type informational television film, or combine a digital film data and a digital type film into a digital type informational television film. The film server may combine the digital film data and the analog type film into a digital type informational television film. The video broadcast system may transmit the analog type informational television film or the digital type informational television film into the user end computer through the second transmission chain. Thus, the video broadcast program non-synchronous watching system may provide various services and functions to the users.

### FIELD OF THE INVENTION

The present invention relates to a video broadcast program non-synchronous watching system, and more particularly to a video broadcast program non-synchronous watching system that may provide various services and functions to the users.

### BACKGROUND OF THE INVENTION

Usually, the functions provided by the programs of the conventional video broadcast system in accordance with the prior art are limited and are not enough. For example, when the watcher switches the channel to his favorite program, the program may have played during a period of time, so that the watcher cannot replay the program.

### SUMMARY OF THE INVENTION

The present invention has arisen to mitigate and/or obviate the disadvantage of the conventional video broadcast system.

The primary objective of the present invention is to provide a video broadcast program non-synchronous watching system that may provide various services and functions to the users.

In accordance with the present invention, there is provided a video broadcast program non-synchronous watching system, comprising: at least one film end computer, at least one film server, at least one video broadcast system, and at least one user end computer, wherein:

the film end computer is connected to the film server through a first computer network, and is connected to the video broadcast system through a first transmission chain, the user end computer is connected to the film server through a second computer network, and is connected to the video broadcast system through a second transmission chain;

the film end computer may combine a digital film data and an analog type film into an analog type informational television film, or combine a digital film data and a digital type film into a digital type informational television film;

the film end computer may transmit the informational television film to the video broadcast system through the first transmission chain;

the video broadcast system may transmit the analog type informational television film or the digital type informational television film into the user end computer through the second transmission chain;

the film server may receive the digital film data sent from the film end computer through the first computer network, and may combine the digital film data and the analog type film into a digital type informational television film, or directly receive the digital type informational television film sent from the film end computer through the first computer network;

the film server may receive and process multiple user end commands sent from the user end computer through the second computer network;

the user end computer may receive and play the analog type informational television film or the digital type informational television film transmitted through the second transmission chain; and

the user end computer may transmit the multiple user end commands to the film server through the second computer network, and may receive the digital type informational television film sent from the film server after processing the multiple user end commands.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of the structure of a video broadcast program non-synchronous watching system in accordance with a preferred embodiment of the present invention;

FIG. 2 is a block view of a video broadcast program non-synchronous watching system in accordance with a preferred embodiment of the present invention;

FIG. 3 is a block view of a video broadcast program non-synchronous watching system in accordance with a preferred embodiment of the present invention;

FIG. 4A is a block view of a first user end computer of the video broadcast program non-synchronous watching system in accordance with a preferred embodiment of the present invention;

FIG. 4B is a block view of a first user end computer of the video broadcast program non-synchronous watching system in accordance with a preferred embodiment of the present invention;

FIG. 4C is a block view of a first user end computer of the video broadcast program non-synchronous watching system in accordance with a preferred embodiment of the present invention;

FIG. 5 is a block view of digital film data of the video broadcast program non-synchronous watching system in accordance with a preferred embodiment of the present invention;

FIG. 6A is a block view of an instant replay command of the video broadcast program non-synchronous watching system in accordance with a preferred embodiment of the present invention;

FIG. 6B is a block view of an instant replay command of the video broadcast program non-synchronous watching system in accordance with a preferred embodiment of the present invention;

FIG. 6C is a block view of an instant replay command of the video broadcast program non-synchronous watching system in accordance with a preferred embodiment of the present invention;

FIG. 7 is a block view of a watching rate statistic command of the video broadcast program non-synchronous watching system in accordance with a preferred embodiment of the present invention;

FIG. 8 is a block view of a preview command of the video broadcast program non-synchronous watching system in accordance with a preferred embodiment of the present invention;

FIG. 9A is a block view of a program recording-only command of the video broadcast program non-synchronous watching system in accordance with a preferred embodiment of the present invention;

FIG. 9B is a flow chart of a program recording-only command of the video broadcast program non-synchronous watching system in accordance with a preferred embodiment of the present invention;

FIG. 10 is a block view of an exit poll command of the video broadcast program non-synchronous watching system in accordance with a preferred embodiment of the present invention;

FIG. 11A is a block view of a full channel reservation recording command of the video broadcast program non-synchronous watching system in accordance with a preferred embodiment of the present invention;

FIG. 11B is a schematic view of a full channel reservation recording command of the video broadcast program non-synchronous watching system in accordance with a preferred embodiment of the present invention;

FIG. 12 is a block view of a different view-angle watching command of the video broadcast program non-synchronous watching system in accordance with a preferred embodiment of the present invention;

FIG. 13 is a block view of a freely watching command of the video broadcast program non-synchronous watching system in accordance with a preferred embodiment of the present invention;

FIG. 14 is a block view of a pause and replay command of the video broadcast program non-synchronous watching system in accordance with a preferred embodiment of the present invention;

FIG. 15A is a block view of a channel program list explore command of the video broadcast program non-synchronous watching system in accordance with a preferred embodiment of the present invention;

FIG. 15B is a flow chart of a channel program list explore command of the video broadcast program non-synchronous watching system in accordance with a preferred embodiment of the present invention; and

FIG. 16 is a block view of a program information watching command of the video broadcast program non-synchronous watching system in accordance with a preferred embodiment of the present invention.

### DETAILED DESCRIPTION OF THE INVENTION

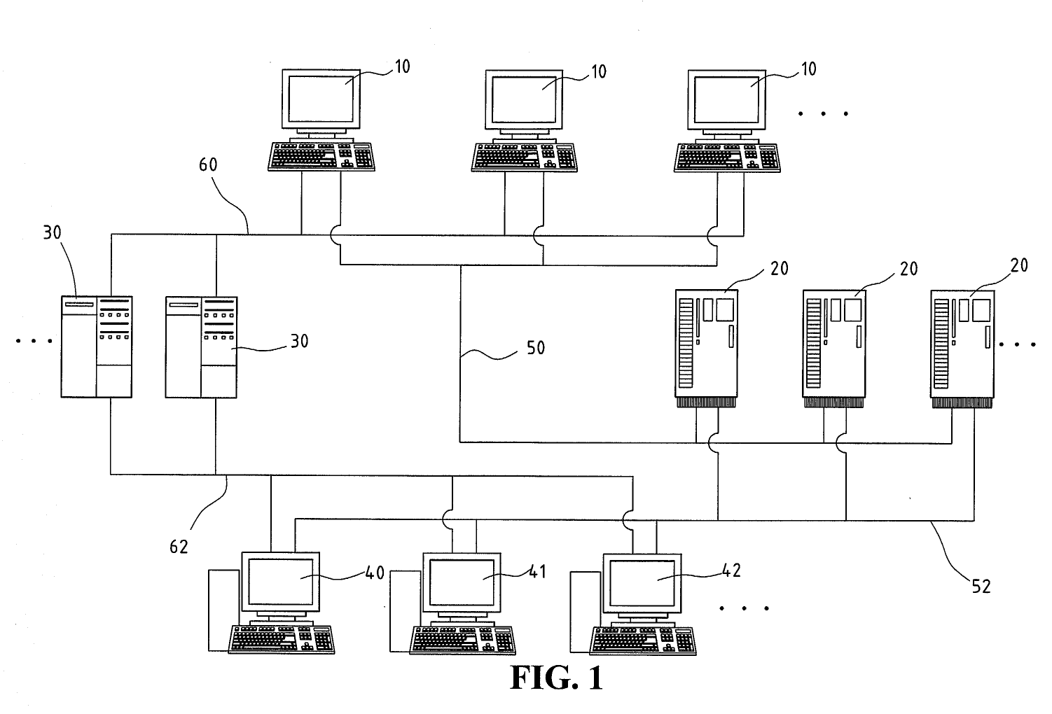

Referring to the drawings and initially to FIG. 1, a video broadcast program non-synchronous watching system in accordance with a preferred embodiment of the present invention comprises at least one film end computer 10, at least one film server 20, at least one video broadcast system 30, and at least one user end computer 40, 41 and 42.

The film end computer 10 is connected to the film server 20 through a first computer network 50, and is connected to the video broadcast system 30 through a first transmission chain 60. The user end computers 40, 41 and 42 are connected to the film server 20 through a second computer network 52, and are connected to the video broadcast system 30 through a second transmission chain 62. Preferably, the first computer network 50 is an internet, and the second computer network 52 is an internet.

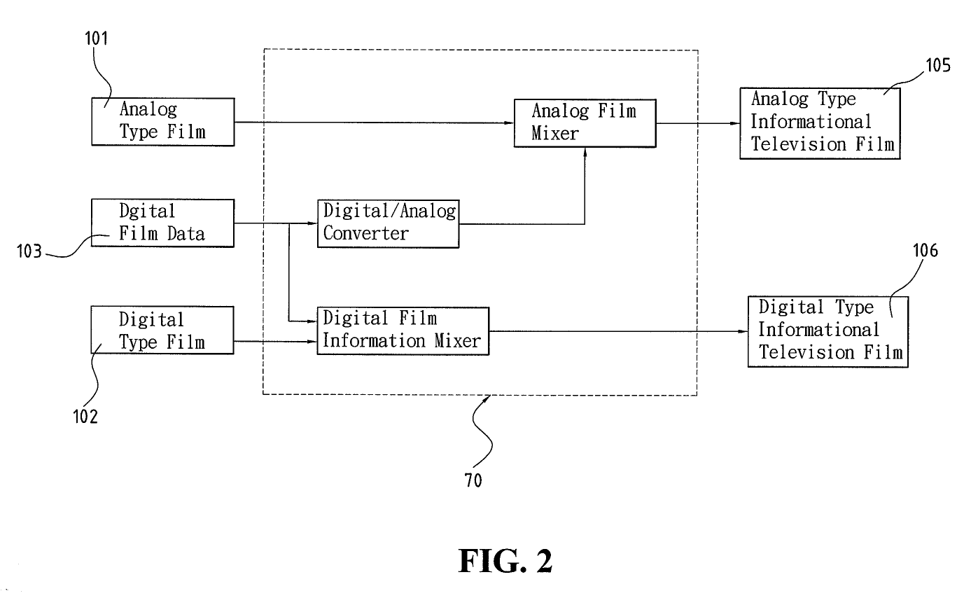

As shown in FIG. 2, according to the requirements, the film end computer 10 may combine the digital film data 103 and the analog type film 101 into an analog type informational television film 105, or combine the digital film data 103 and the digital type film 102 into a digital type informational television film 106. In practice, the film end computer 10 may mix the digital film data 103 and the analog type film 101 into an analog type informational television film 105, or mix the digital film data 103 and the digital type film 102 into an digital type informational television film 106 by a film information mixer 70 as shown in FIG. 2.

The film end computer 10 may transmit the analog type informational television film 105 or the digital type informational television film 106 to the video broadcast system 30 through the first transmission chain 60. The video broadcast system 30 may transmit the analog type informational television film 105 into the user end computer 40 through the second transmission chain 62. The video broadcast system 30 is a wire propagation video broadcast program company or a wireless propagation video broadcast program company that may provide the video broadcast program. Thus, the first transmission chain 60 may be a wire cable or wire network, and may be a wireless electric wave or wireless network, and the second transmission chain 62 may be a wire cable or wire network, and may be a wireless electric wave or wireless network.

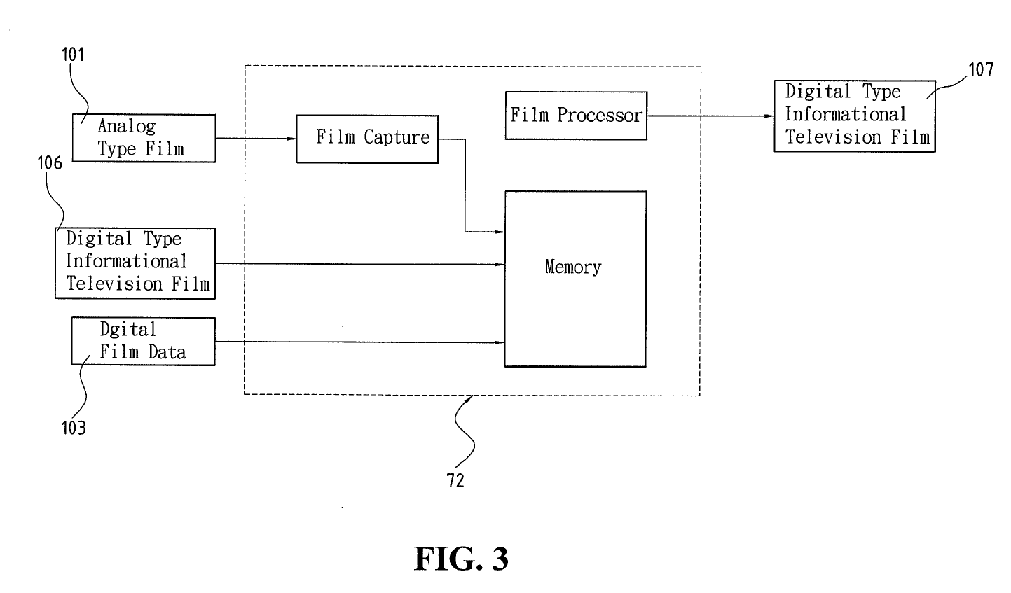

As shown in FIG. 3, the film server 20 may receive the digital film data 103 sent from the film end computer 10 through the first computer network 50, and may combine the digital film data 103 and the analog type film 101 into a digital type informational television film 107. In practice, the film server 20 may mix the digital film data 103 and the analog type film 101 into the digital type informational television film 107 by a film digitized mixer 72 as shown in FIG. 3. The film server 20 may also receive the digital type informational television film 106 sent from the film end computer 10 through the first computer network 50, to convert the digital type informational television film 106 into a digital type informational television film 107. The film server 20 may further include a data base for storing multiple digital type informational television films 107.

The first type user end computer 40 may receive and play the analog type informational television film 105 transmitted through the second transmission chain 62 (wire cable or wireless electric wave). The second type user end computer 41 may receive and play the digital type informational television film 106 transmitted through the second transmission chain 62 (wire cable or wireless electric wave). The third type user end computer 42 may receive and play the digital type informational television film 106 transmitted through the second transmission chain 62 (wire network or wireless network). At the same time, the user end computers 40, 41 and 42 may transmit multiple user end commands 109 to the film server 20 through the second computer network 52, and may receive the digital type informational television film 107 sent from the film server 20 after processing the multiple user end commands 109.

In addition, the film server 20 may receive and process the multiple user end commands 109 sent from the user end computer 40 through the second computer network 52.

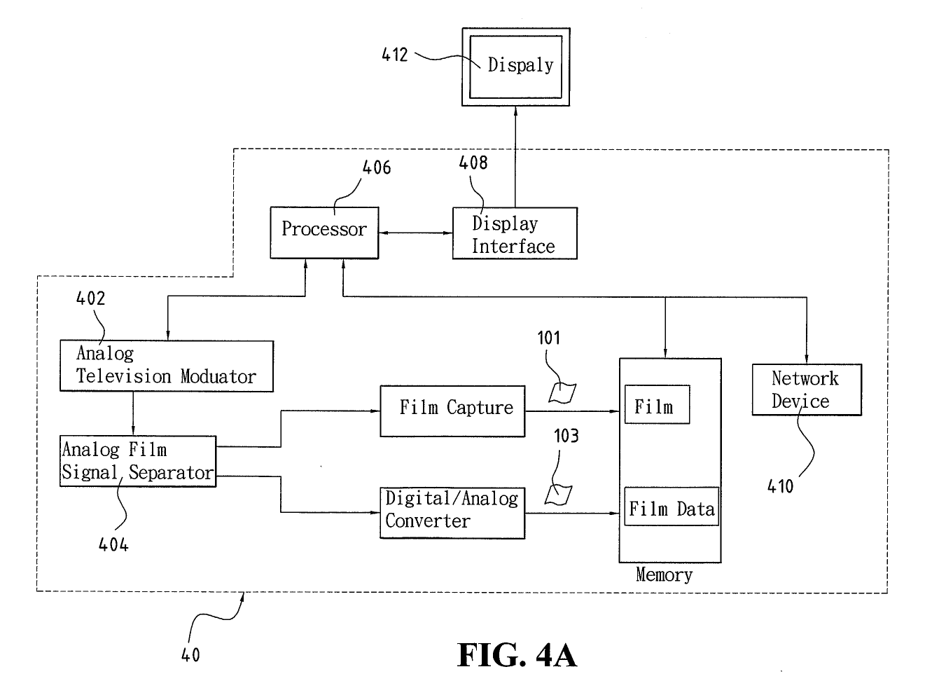

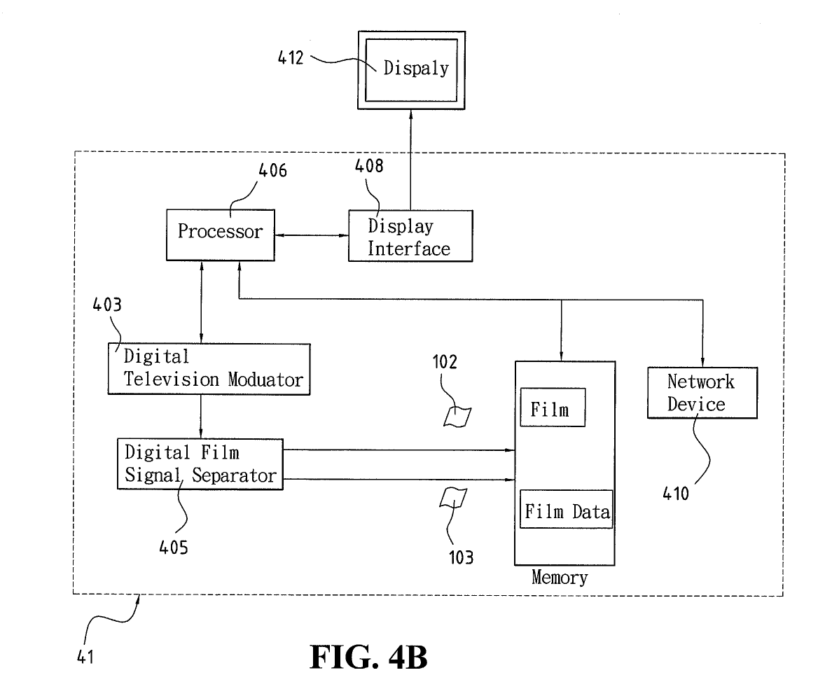

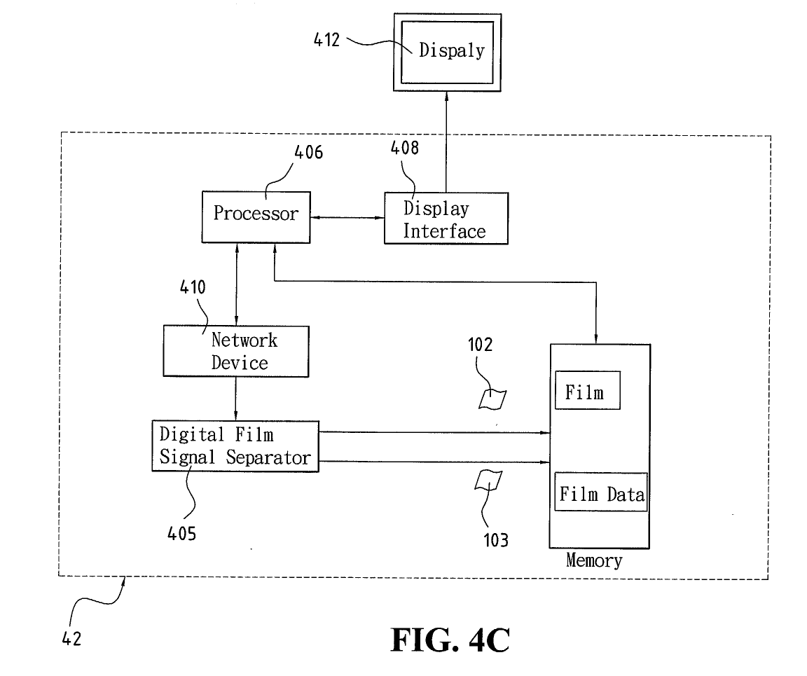

As shown in FIG. 4A, the first type user end computer 40 at least includes an analog television modulator 402, for receiving the analog type informational television film 105, an analog film signal separator 404, for separating the analog type informational television film 105 into the digital film data 103 and the analog type film 101, a network device 410 for connecting the second computer network 52, a display interface 408, for outputting the analog type film 101 or the digital type informational television film 107 into a display 412, and a processor 406, for processing the multiple user end commands 109 and the digital film data 103.

As shown in FIG. 4B, the second type user end computer 41 at least includes a digital television modulator 403, for receiving the digital type informational television film 106, a digital film signal separator 405, for separating the digital type informational television film 106 into the digital film data 103 and the digital type film 102, a network device 410 for connecting the second computer network 52, a display interface 408, for outputting the digital type film 102 or the digital type informational television film 107 into a display 412, and a processor 406, for processing the multiple user end commands 109 and the digital film data 103.

As shown in FIG. 4C, the third type user end computer 42 at least includes a network device 410, for receiving the digital type informational television film 106, and for connecting the second computer network 52, a digital film signal separator 405, for separating the digital type informational television film 106 into the digital film data 103 and the digital type film 102, a display interface 408, for outputting the digital type film 102 or the digital type informational television film 107 into a display 412, and a processor 406, for processing the multiple user end commands 109 and the digital film data 103.

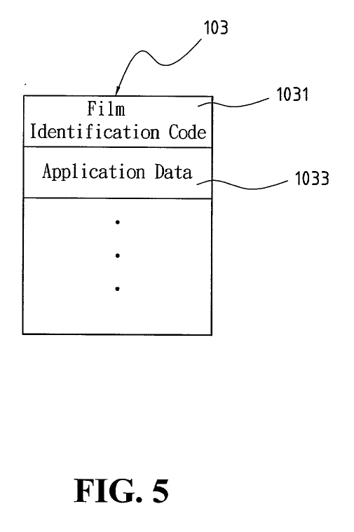

FIG. 5 shows the data structure of the digital film data. The digital film data 103 at least includes film identification code 1031, for identifying each digital type informational television film 107, and application data 1033, for describing the contents concerning the film, such as characters or numbers that may be used by the multiple user end commands 109.

The multiple user end commands 109 of the video broadcast program non-synchronous watching system in accordance with a preferred embodiment of the present invention may have various applications. The multiple user end commands 109 at least include an instant replay command, a watching rate statistic command, a preview command, a program recording-only command, and an exit poll command. The user end computer 40 and the film server 20 may be used to process the instant replay command, the watching rate statistic command, the preview command, the program recording-only command and the exit poll command of the multiple user end commands 109, so that when the user is watching the analog type informational television film 105 or the digital type informational television film 106 transmitted through the second transmission chain 62, the watched analog type film 101 may be processed by the instant replay command, the watching rate statistic command, the preview command, the program recording-only command, and the exit poll command.

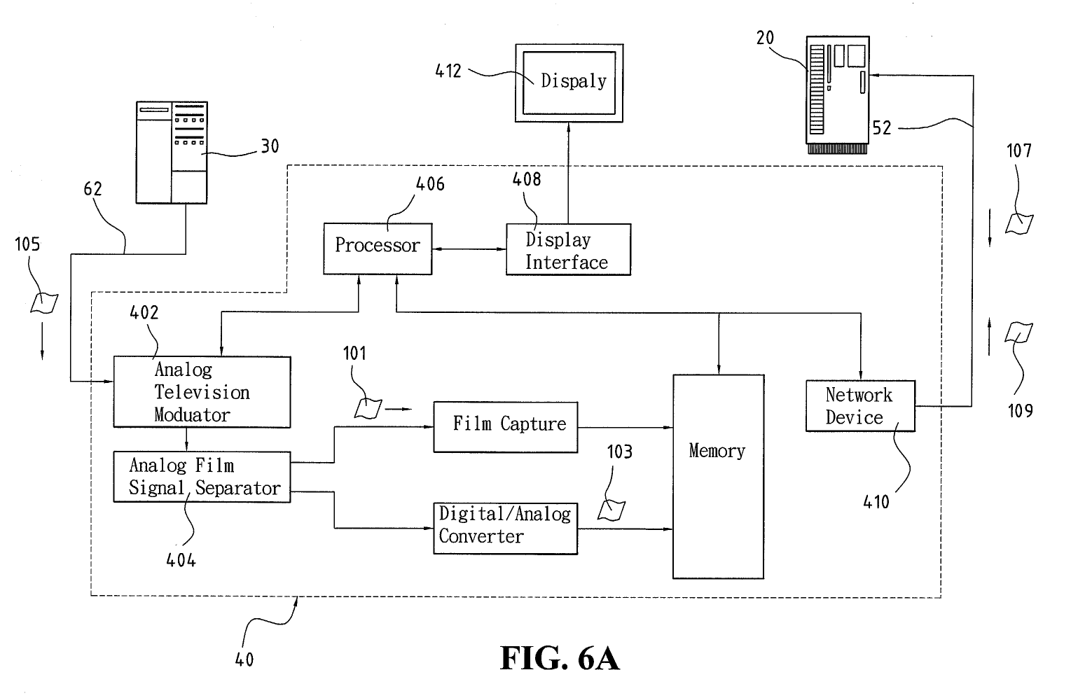

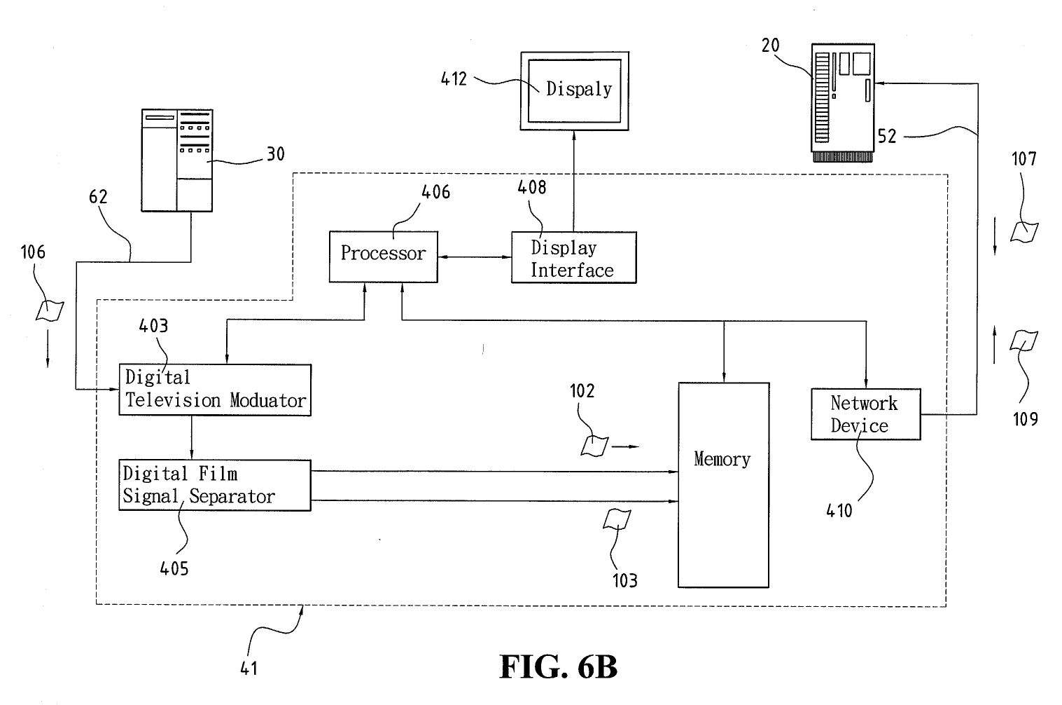

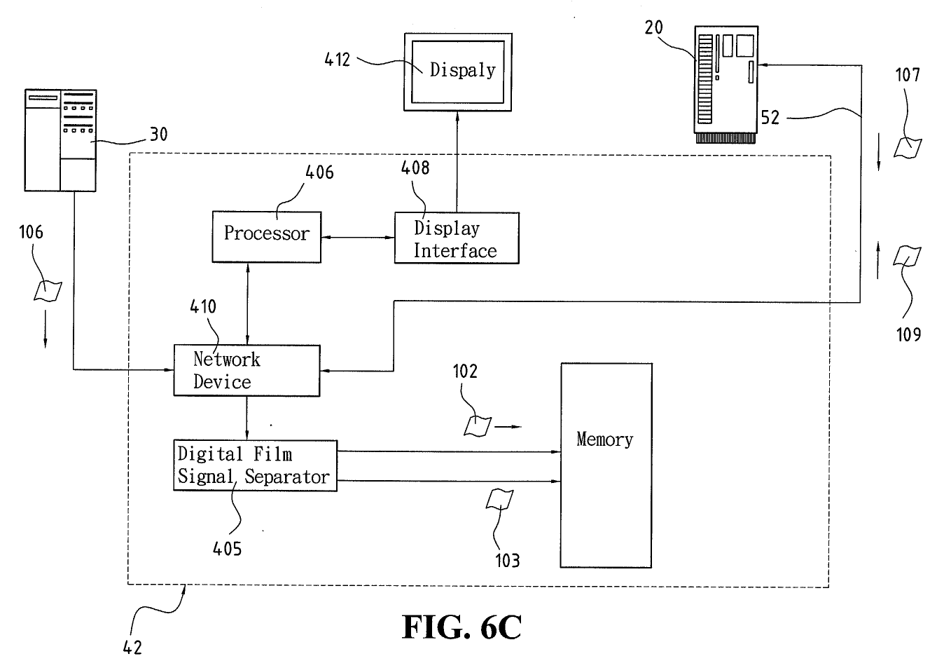

As shown in FIG. 6A, the video broadcast program non-synchronous watching system in accordance with a preferred embodiment of the present invention may be used to perform the instant replay command.

When the user of the user end computer 40 is watching the analog type informational television film 105 through the analog television modulator 402, an input device (not shown), such as a remote controller, may be used by the user end computer 40. The user may press a button of the input device to send a signal that is processed by the processor 406, thereby forming a computer network packet having an instant replay command 109. The computer network packet having an instant replay command 109 may be sent through the network device 410 and the second computer network 52 into the film server 20 to be processed by the film server 20. Then, after processing, the film server 20 may send the digital type informational television film 107 that mates with the analog type informational television film 105 to the user end computer 40, so that the user may instantly replay the film.

As shown in FIG. 6B, the video broadcast program non-synchronous watching system in accordance with another preferred embodiment of the present invention may be used to perform the instant replay command. The procedures of FIG. 6B are similar to that of FIG. 6A, and the difference is in that, the user of the user end computer 41 is watching the digital type informational television film 106 through the digital television modulator 403.

As shown in FIG. 6C, the video broadcast program non-synchronous watching system in accordance with another preferred embodiment of the present invention may be used to perform the instant replay command. The procedures of FIG. 6C are similar to that of FIG. 6A, and the difference is in that, the user of the user end computer 42 is watching the digital type informational television film 106 through the network device 410.

In the following descriptions, the user end computer 40 and the analog type informational television film 105 are taken for example.

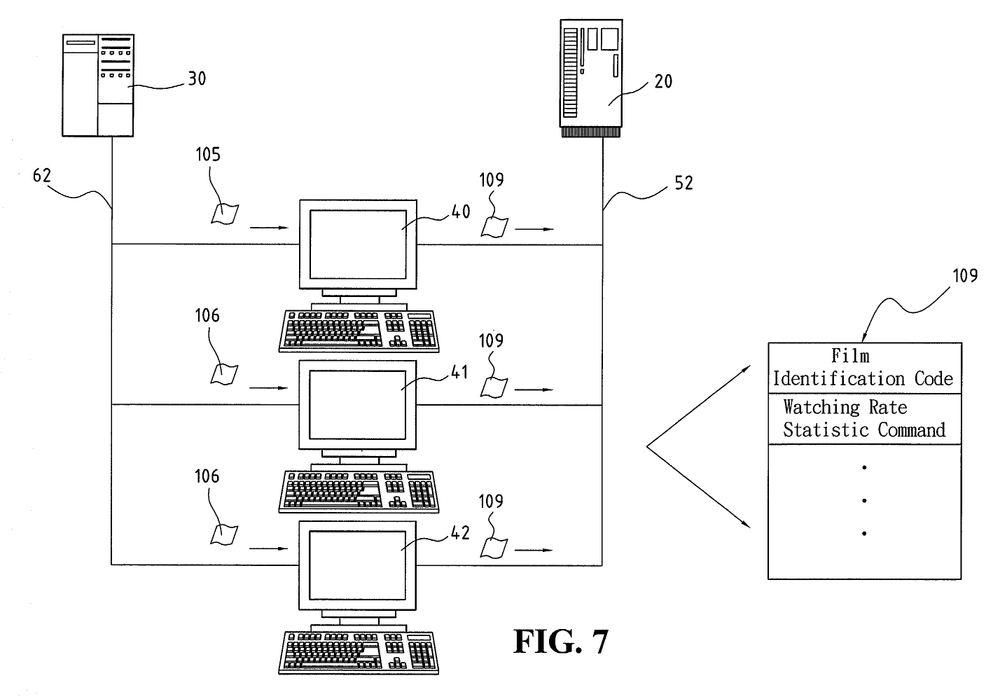

As shown in FIG. 7, the video broadcast program non-synchronous watching system in accordance with a preferred embodiment of the present invention may be used to perform the watching rate statistic command.

When the user of the user end computer 40 is watching the analog type informational television film 105 through the analog television modulator 402, if the channel is not changed during a period of time, such as five minutes, the processor 406 may form a computer network packet having a watching rate statistic command. The computer network packet having a watching rate statistic command may be sent through the network device 410 and the second computer network 52 into the film server 20 to be processed by the film server 20. Then, after processing, the film server 20 may count the watching records of the film.

As shown in FIG. 8, the video broadcast program non-synchronous watching system in accordance with a preferred embodiment of the present invention may be used to perform the preview command.

When the user of the user end computer 40 is watching the analog type informational television film 105 through the analog television modulator 402, an input device (not shown), such as a remote controller, may be used by the user end computer 40. The user may press a button of the input device to send a signal that is processed by the processor 406, thereby forming a computer network packet having a preview command 109. The computer network packet having a preview command 109 may be sent through the network device 410 and the second computer network 52 into the film server 20 to be processed by the film server 20. Then, after processing, the film server 20 may send the digital type informational television film 107 that mates with the analog type informational television film 105 to the user end computer 40, so that the user may preview the film without having to wait.

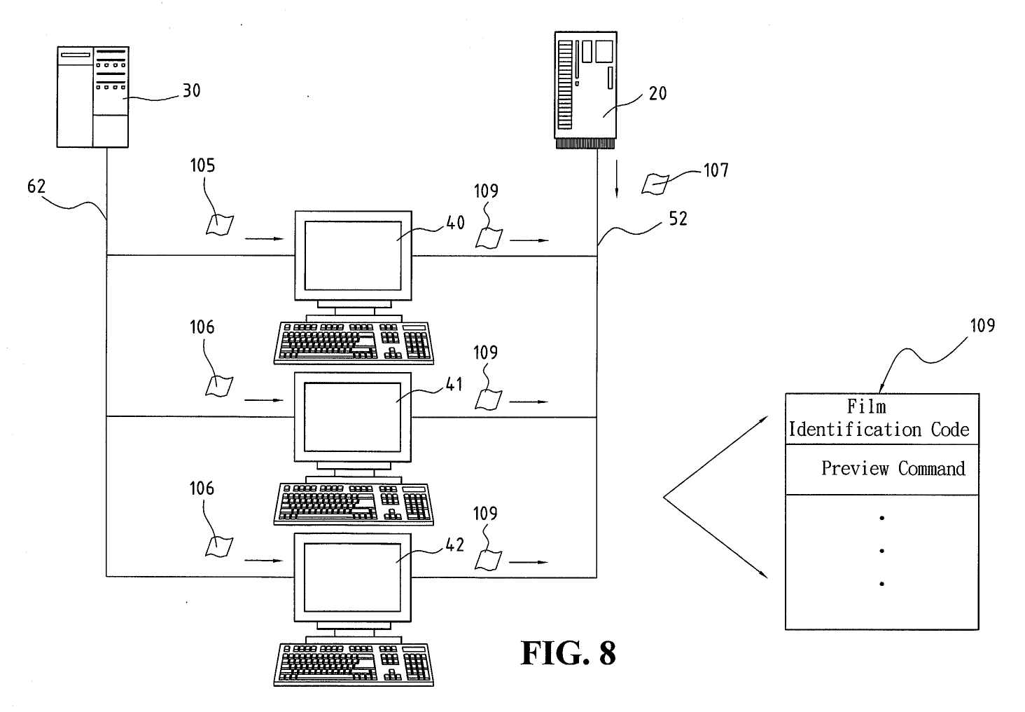

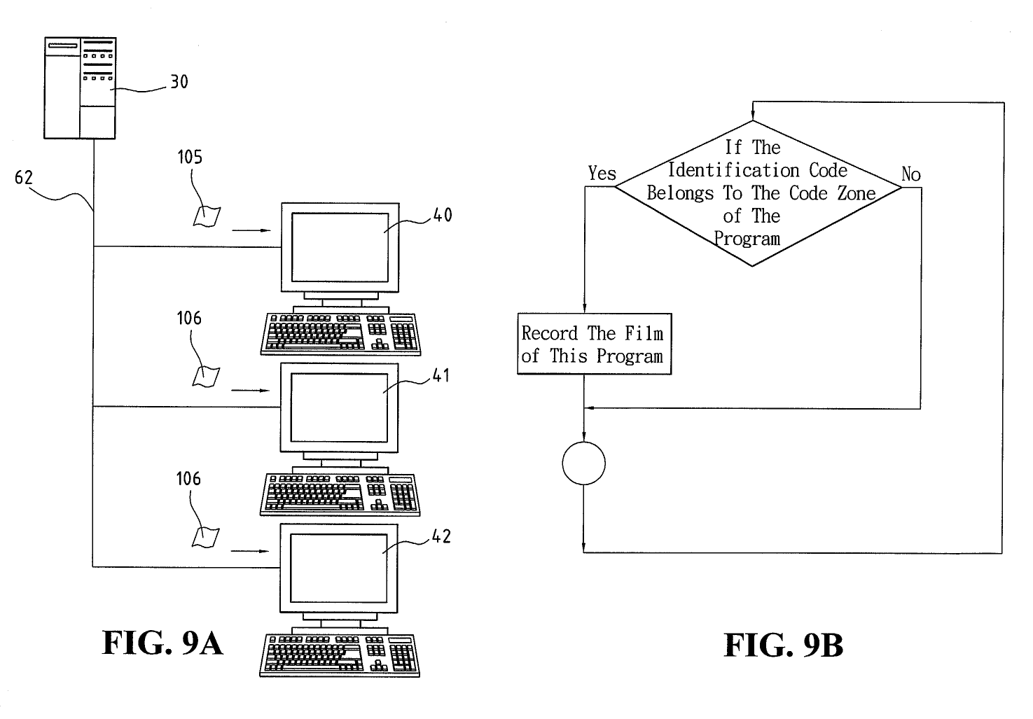

As shown in FIG. 9A, the video broadcast program non-synchronous watching system in accordance with a preferred embodiment of the present invention may be used to perform the program recording-only command.

When the user of the user end computer 40 is watching the analog type informational television film 105 through the analog television modulator 402, an input device (not shown), such as a remote controller, may be used by the user end computer 40. The user may press a button of the input device to perform the program recording-only command. Thus, according to the flow chart as shown in FIG. 9B, the processor 406 may identify if the film identification code 1031 belongs to the code zone of the program. If so, the film belongs to the program, so that the user may record the film of this program. If not so, the film belongs to the advertisement, so that the user may pass the advertisement.

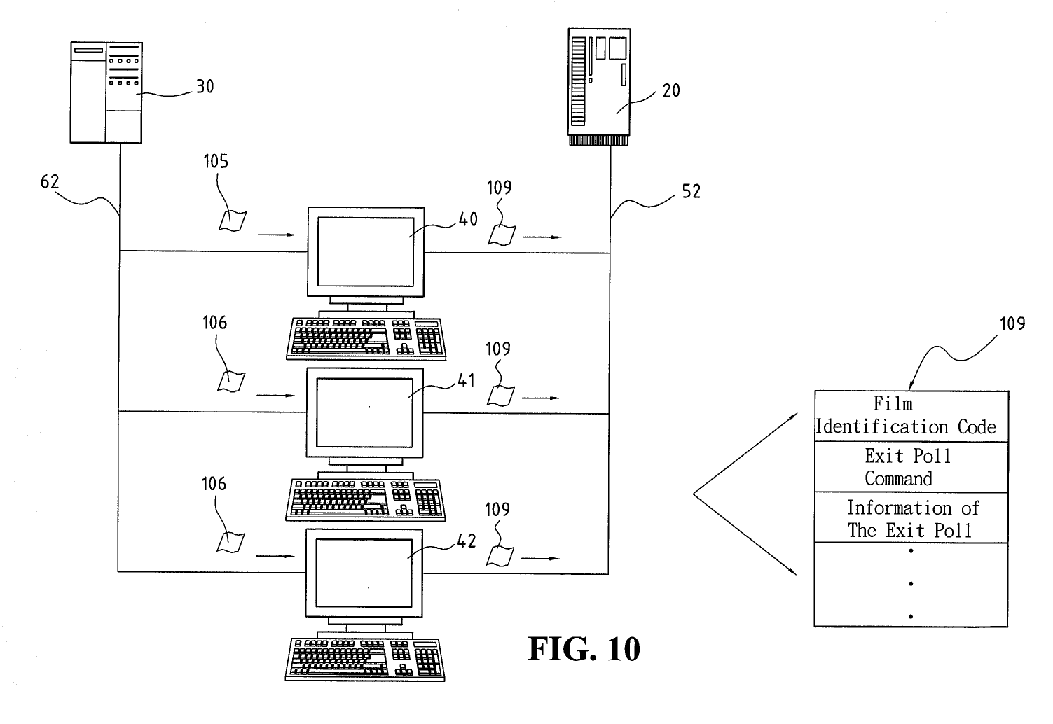

As shown in FIG. 10, the video broadcast program non-synchronous watching system in accordance with a preferred embodiment of the present invention may be used to perform the exit poll command.

When the user of the user end computer 40 is watching the analog type informational television film 105 through the analog television modulator 402, an input device (not shown), such as a remote controller, a cursor or a keyboard, may be used by the user end computer 40. The user may press a button of the input device to send a signal that is processed by the processor 406, thereby forming a computer network packet having an exit poll command 109. The computer network packet having a an exit poll command 109 may be sent through the network device 410 and the second computer network 52 into the film server 20 to be processed by the film server 20. Then, after processing, the film server 20 may obtain the information of the exit poll.

On the other hand, the multiple user end commands 109 further include a full channel reservation recording command, a different view-angle watching command, a freely watching command, a pause and replay command, a channel program list explore command, and a program information watching command.

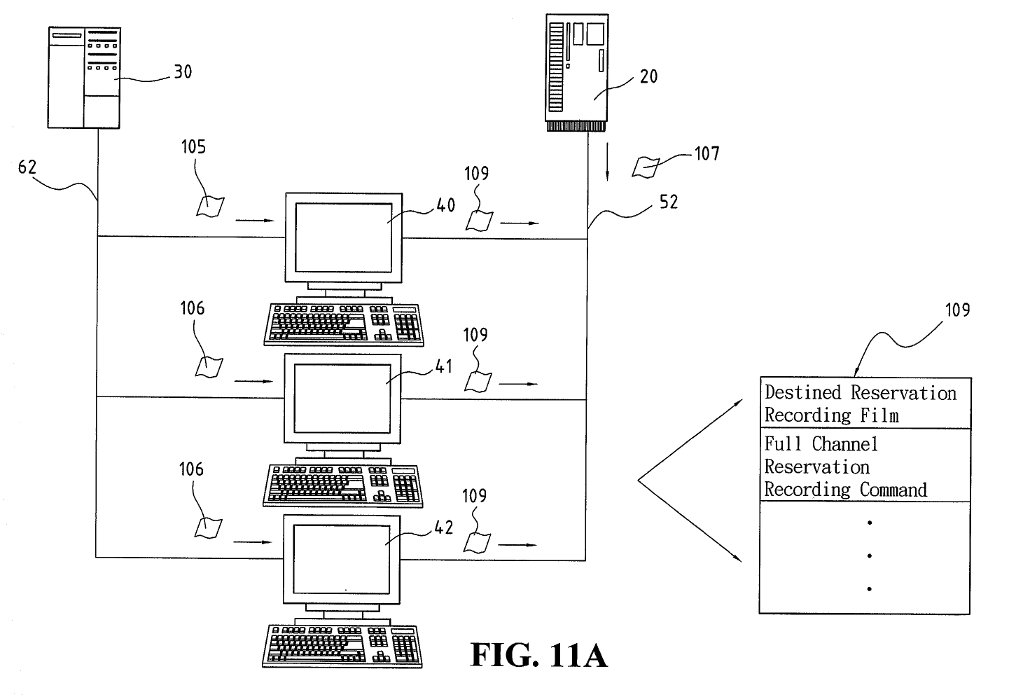

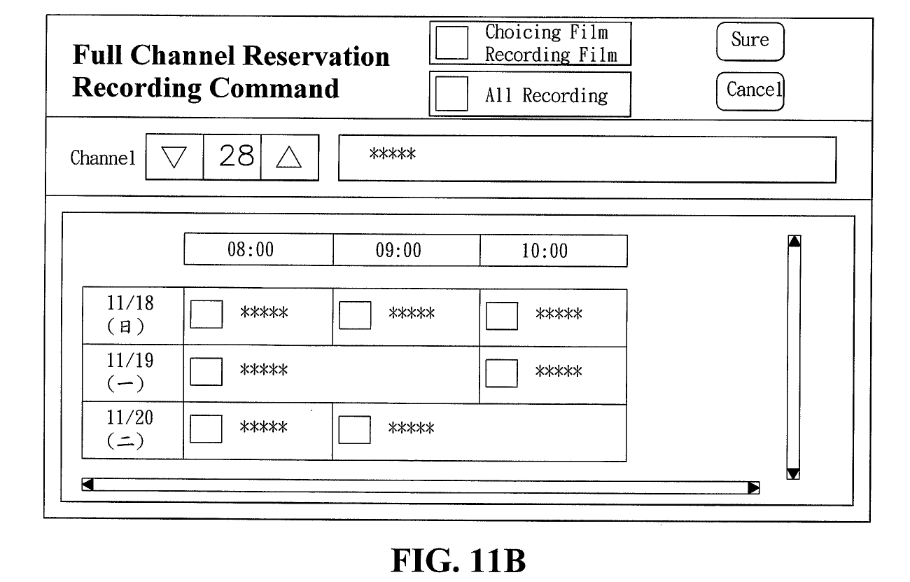

As shown in FIG. 11A, the video broadcast program non-synchronous watching system in accordance with a preferred embodiment of the present invention may be used to perform the full channel reservation recording command.

When the user of the user end computer 40 is watching the analog type informational television film 105 as shown in FIG. 11B, an input device (not shown), such as a remote controller, may be used by the user end computer 40. The user may press a button of the input device to input the reservation recording film, which sends a signal that is processed by the processor 406, thereby forming a computer network packet having a full channel reservation recording command 109. The computer network packet having a full channel reservation recording command 109 may be sent through the network device 410 and the second computer network 52 into the film server 20 to be processed by the film server 20. Then, after processing, the film server 20 may store the destined film, and send the destined digital type informational television film 107 to the user end computer 40 to perform a recording process, thereby satisfying the user's full channel reservation recording requirement.

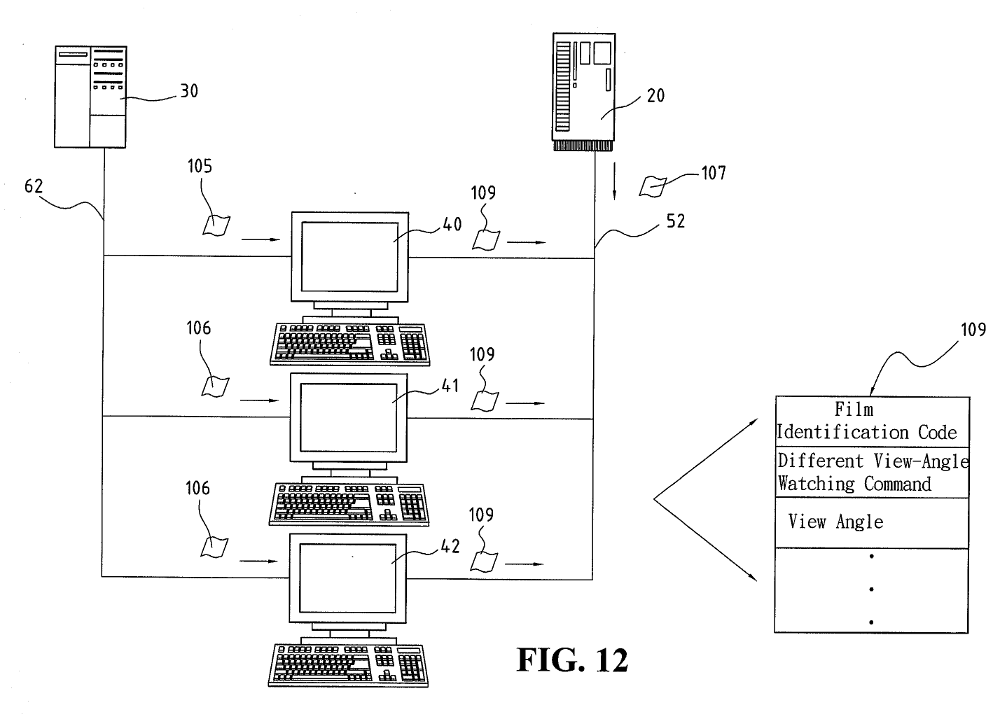

As shown in FIG. 12, the video broadcast program non-synchronous watching system in accordance with a preferred embodiment of the present invention may be used to perform the different view-angle watching command.

When the user of the user end computer 40 is watching the analog type informational television film 105, an input device (not shown), such as a remote controller, may be used by the user end computer 40. The user may press a button of the input device to input the requirements which send a signal that is processed by the processor 406, thereby forming a computer network packet having a different view-angle watching command 109. The computer network packet having a different view-angle watching command 109 may be sent through the network device 410 and the second computer network 52 into the film server 20 to be processed by the film server 20. Then, after processing, the film server 20 may send the digital type informational television film 107 that mates with the analog type informational television film 105 to the user end computer 40, so that the user may watch the film at his favorite view-angle, thereby satisfying the user's different view-angle watching requirement.

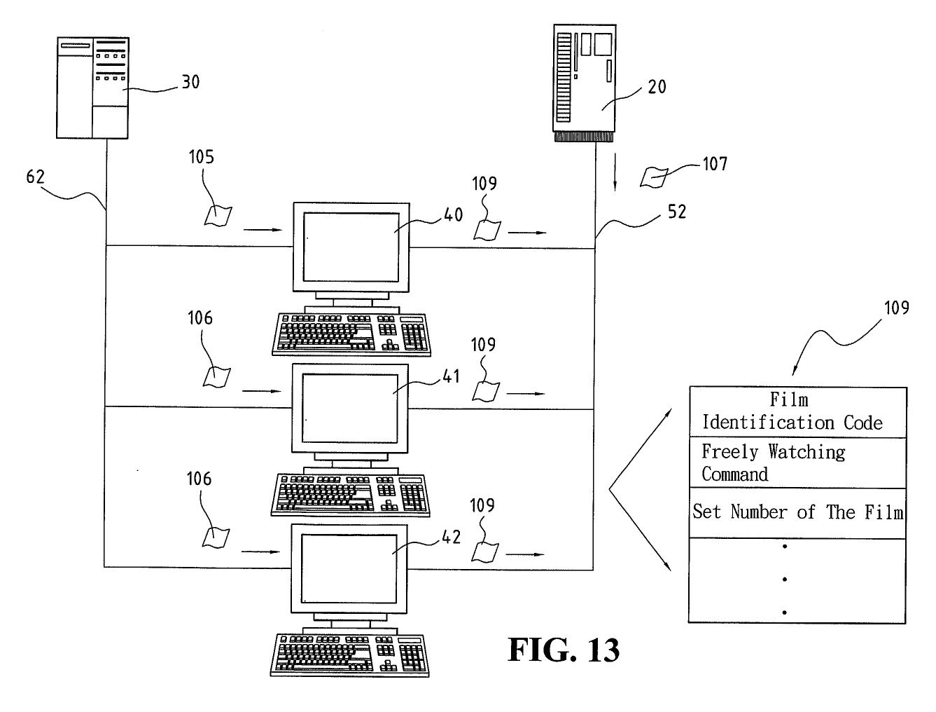

As shown in FIG. 13, the video broadcast program non-synchronous watching system in accordance with a preferred embodiment of the present invention may be used to perform the freely watching command.

When the user of the user end computer 40 is watching the analog type informational television film 105, an input device (not shown), such as a remote controller, may be used by the user end computer 40. The user may press a button of the input device to select the set of film he wants to watch, and to send a signal that is processed by the processor 406, thereby forming a computer network packet having a freely watching command 109. The computer network packet having a freely watching command 109 may be sent through the network device 410 and the second computer network 52 into the film server 20 to be processed by the film server 20. Then, after processing, the film server 20 may send the digital type informational television film 107 that mates with the analog type informational television film 105 to the user end computer 40, so that the user may watch any set of film, thereby satisfying the user's freely watching requirement.

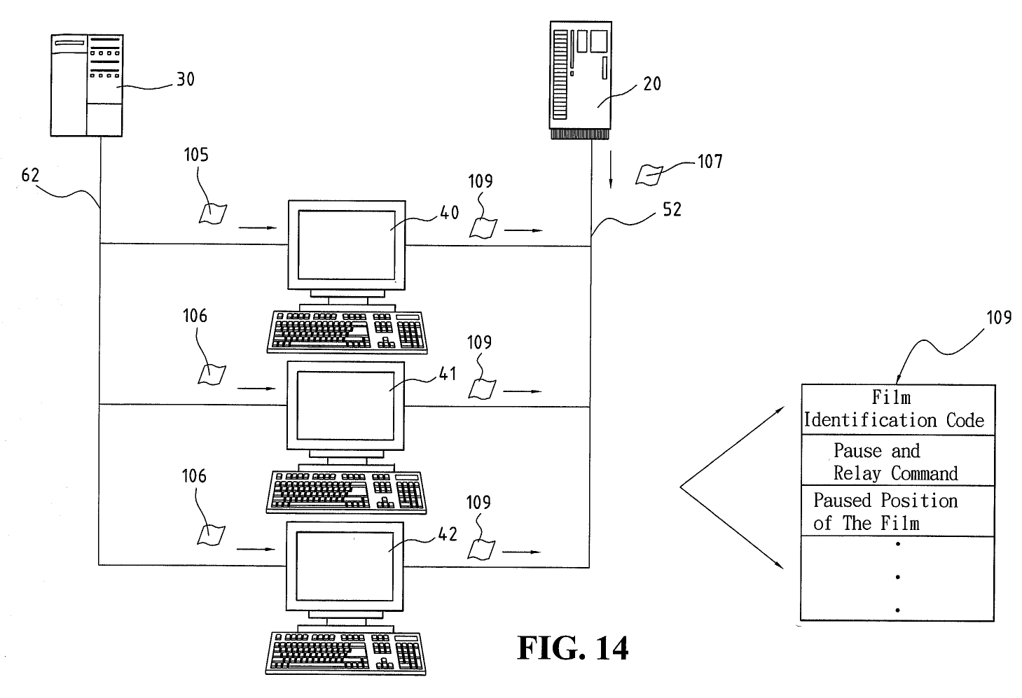

As shown in FIG. 14, the video broadcast program non-synchronous watching system in accordance with a preferred embodiment of the present invention may be used to perform the pause and replay command.

When the user of the user end computer 40 is watching the analog type informational television film 105, an input device (not shown), such as a remote controller, may be used by the user end computer 40. The user may press a button of the input device to input the pause and replay command which may be sent to the processor 406 which may pause the video signal processing and pause the picture, and may form a computer network packet having a pause and replay command 109. After the user presses the button to continue the program, the computer network packet having a pause and replay command 109 may be sent through the network device 410 and the second computer network 52 into the film server 20 to be processed by the film server 20. Then, after processing, the film server 20 may send the digital type informational television film 107 to the user end computer 40, so that the user may continue to watch the original film, thereby satisfying the user's pause and replay requirement.

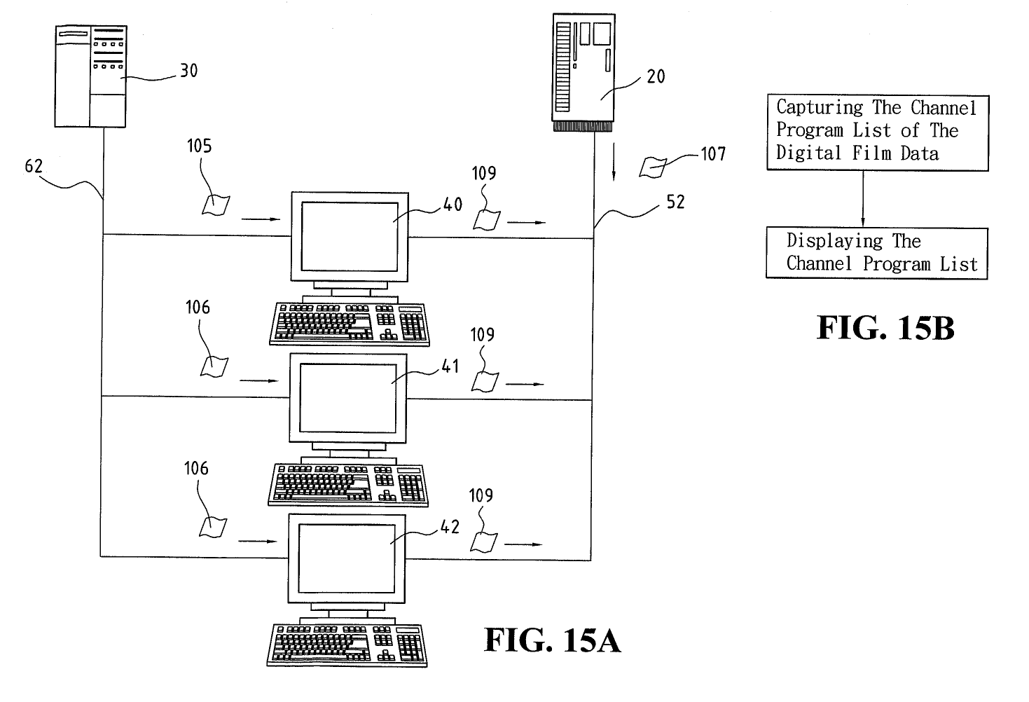

As shown in FIG. 15A, the video broadcast program non-synchronous watching system in accordance with a preferred embodiment of the present invention may be used to perform the channel program list explore command.

When the user of the user end computer 40 is watching the analog type informational television film 105, a flow chart as shown in FIG. 15B may be used to process the channel program list explore command. At this time, the user end computer 40 may automatically capture the digital film data 103 which contains the channel program list. An input device (not shown), such as a remote controller, may be used by the user end computer 40. The user may press a button of the input device to perform the channel program list explore command, so that the display 412 may indicate the contents of the channel program list. The digital film data 103 further contains clock synchronous data, for adjusting the time of the clock of the user end computer 40 to mate the time of the video broadcast system 30.

Thus, the present invention has the following advantages.

1. The time of the clock of the user end computer 40 to mate the time of the video broadcast system 30, thereby preventing incurring errors in time.

2. The channel name may be used to replace the channel number, so that the user may explore the channel program list, thereby preventing incurring errors due to different channel numbers at different zones.

3. After the channel program list explore command is performed, the channel program list may be updated.

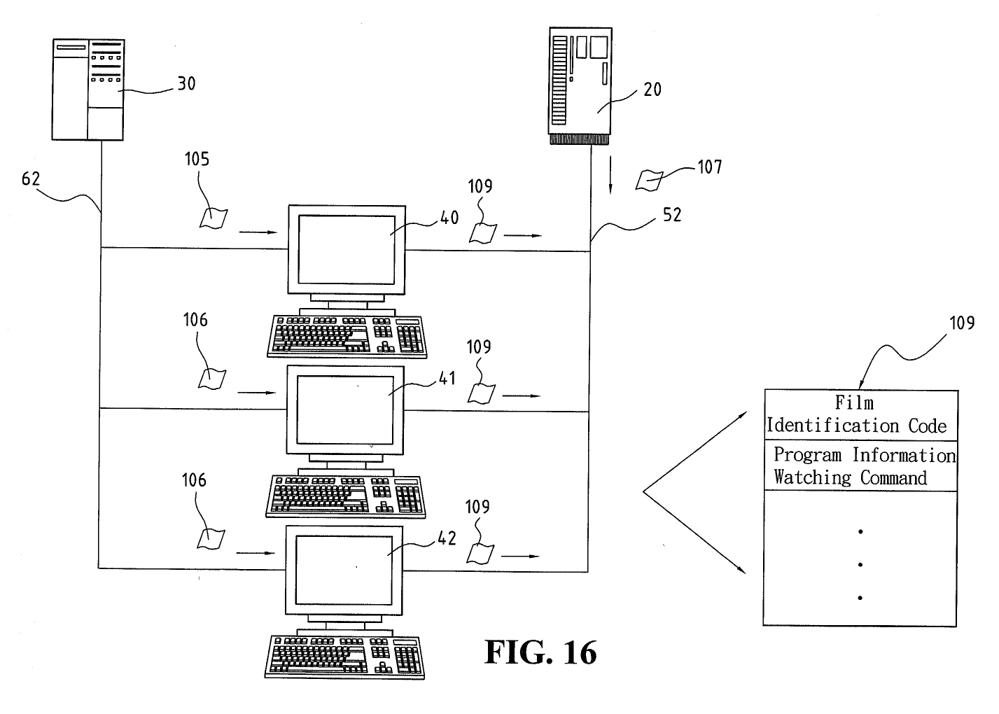

As shown in FIG. 16, the video broadcast program non-synchronous watching system in accordance with a preferred embodiment of the present invention may be used to perform the program information watching command.

When the user of the user end computer 40 is watching the analog type informational television film 105, an input device (not shown), such as a remote controller, may be used by the user end computer 40. The user may press a button of the input device to input the program information watching command which may be sent to the processor 406 which may process the program information watching command, thereby forming a computer network packet having a program information watching command 109. The computer network packet having a program information watching command 109 may be sent through the network device 410 and the second computer network 52 into the film server 20 to be processed by the film server 20. Then, after processing, the film server 20 may send the program information to the user end computer 40, so that the user may watch the related information of the program, thereby satisfying the user's program information watching requirement.

Accordingly, the video broadcast program non-synchronous watching system in accordance with a preferred embodiment of the present invention has the following advantages.

1. The user may pause or replay the film without having to perform the recording work.

2. The user may watch any set of films without having to perform the recording work.

3. The user may preview the film, without having to wait.

4. The user may record the film without recording the advertisement.

5. The information of the film may be indicated synchronously when the user is watching any film.

6. The user's television film may have the watching rate statistic and exit poll functions.

7. The user may explore the channel program list.

8. The user may make the personal television station.

9. The user may select different view angles to watch the film.

10. The present invention may have the full channel reservation recording function.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A video broadcast program non-synchronous watching system, comprising: at least one film end computer, at least one film server, at least one video broadcast system, and at least one user end computer, wherein:
the film end computer is connected to the film server through a first computer network, and is connected to the video broadcast system through a first transmission chain, the user end computer is connected to the film server through a second computer network, and is connected to the video broadcast system through a second transmission chain;
the film end computer may combine a digital film data and an analog type film into an analog type informational television film, or combine a digital film data and a digital type film into a digital type informational television film;
the film end computer may transmit the informational television film to the video broadcast system through the first transmission chain;
the video broadcast system may transmit the analog type informational television film or the digital type informational television film into the user end computer through the second transmission chain;
the film server may receive the digital film data sent from the film end computer through the first computer network, and may combine the digital film data and the analog type film into a digital type informational television film, or directly receive the digital type informational television film sent from the film end computer through the first computer network;
the film server may receive and process multiple user end commands sent from the user end computer through the second computer network;
the user end computer may receive and play the analog type informational television film or the digital type informational television film transmitted through the second transmission chain; and
the user end computer may transmit the multiple user end commands to the film server through the second computer network, and may receive the digital type informational television film sent from the film server after processing the multiple user end commands.

2. The video broadcast program non-synchronous watching system in accordance with claim 1, wherein the video broadcast system is an analog type broadcast program system.

3. The video broadcast program non-synchronous watching system in accordance with claim 1, wherein the video broadcast system is a digital type broadcast program system.

4. The video broadcast program non-synchronous watching system in accordance with claim 1, wherein the first computer network is an internet.

5. The video broadcast program non-synchronous watching system in accordance with claim 1, wherein the second computer network is an internet.

6. The video broadcast program non-synchronous watching system in accordance with claim 1, wherein the multiple user end commands at least include an instant replay command, a watching rate statistic command, a preview command, a program recording-only command, and an exit poll command.

7. The video broadcast program non-synchronous watching system in accordance with claim 1, wherein the multiple user end commands further include a full channel reservation recording command, a different view-angle watching command, a freely watching command, a pause and replay command, a channel program list explore command, and a program information watching command.

8. The video broadcast program non-synchronous watching system in accordance with claim 1, wherein the film server at least includes a data base for storing the digital type informational television film.

9. The video broadcast program non-synchronous watching system in accordance with claim 1, wherein the user end computer at least includes an analog television modulator, for receiving the analog type informational television film, an analog film signal separator, for separating the analog type informational television film into the digital film data and the analog type film, a network device for connecting the second computer network, a display interface, for outputting the analog type film or the digital type informational television film into a display, and a processor, for processing the multiple user end commands and the digital film data.

10. The video broadcast program non-synchronous watching system in accordance with claim 1, wherein the type user end computer at least includes a digital television modulator, for receiving the digital type informational television film, a digital film signal separator, for separating the digital type informational television film into the digital film data and the digital type film, a network device for connecting the second computer network, a display interface, for outputting the digital type film or the digital type informational television film into a display, and a processor, for processing the multiple user end commands and the digital film data.

11. The video broadcast program non-synchronous watching system in accordance with claim 1, wherein the third type user end computer at least includes a network device, for receiving the digital type informational television film, and for connecting the second computer network, a digital film signal separator, for separating the digital type informational television film into the digital film data and the digital type film, a display interface, for outputting the digital type film or the digital type informational television film into a display, and a processor, for processing the multiple user end commands and the digital film data.

12. The video broadcast program non-synchronous watching system in accordance with claim 1, wherein the digital film data at least includes film identification code, for identifying each digital type informational television film, and application data, for describing the contents concerning the film.

13. The video broadcast program non-synchronous watching system in accordance with claim 1, wherein the first transmission chain is a wire cable.

14. The video broadcast program non-synchronous watching system in accordance with claim 1, wherein the first transmission chain is a wireless electric wave.

15. The video broadcast program non-synchronous watching system in accordance with claim 1, wherein the first transmission chain is a satellite broadcast.

16. The video broadcast program non-synchronous watching system in accordance with claim 1, wherein the first transmission chain is a wire network.

17. The video broadcast program non-synchronous watching system in accordance with claim 1, wherein the first transmission chain is a wireless network.

18. The video broadcast program non-synchronous watching system in accordance with claim 1, wherein the second transmission chain is a wire cable.

19. The video broadcast program non-synchronous watching system in accordance with claim 1, wherein the second transmission chain is a wireless electric wave.

20. The video broadcast program non-synchronous watching system in accordance with claim 1, wherein the second transmission chain is a wire network.

21. The video broadcast program non-synchronous watching system in accordane with claim 1, wherein the second transmission chain is a wireless network.
